(19) United States
(12) Patent Application Publication
(10) Pub. No.: US 2022/0375456 A1
(43) Pub. Date: Nov. 24, 2022

(54) METHOD FOR ANIMATION SYNTHESIS, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Shaoxiong YANG, Beijing (CN); Chen ZHAO, Beijing (CN)

(21) Appl. No.: 17/855,438

(22) Filed: Jun. 30, 2022

(30) Foreign Application Priority Data
Aug. 12, 2021 (CN) 202110925368.9

(51) Int. Cl. G10L 15/02; G06T 13/00

(52) U.S. Cl. CPC G10L 15/02; G06T 13/00; G10L 2015/025; G10L 2015/027

(57) ABSTRACT

A method for animation synthesis includes: obtaining an audio stream to be processed and a syllable sequence, wherein both the audio stream and the syllable sequence correspond to the same text and each syllable in the syllable sequence is pinyin of each character of the text; obtaining a phoneme information sequence of the audio stream by performing phoneme detection on the audio stream, wherein each piece of phoneme information in the phoneme information sequence comprises a phoneme category and a pronunciation time period; determining a pronunciation time period corresponding to each syllable in the syllable sequence based on the syllable sequence, phoneme categories and pronunciation time periods in the phoneme information sequence; and generating an animation video corresponding to the audio stream based on the pronunciation time period corresponding to each syllable in the syllable sequence and an animation frame sequence corresponding to each syllable.

### CROSS-REFERENCE TO RELATED APPLICATION

This application is based upon and claims priority to Chinese Patent Application No. 202110925368.9, filed on Aug. 12, 2021, the entire content of which are incorporated herein by reference.

### TECHNICAL FIELD

The disclosure relates to the technical field of artificial intelligence (AI), especially to the technical fields of natural language processing, speech technology, computer vision and virtual/augmented reality, and in particular to a method for animation synthesis, an apparatus for animation synthesis, an electronic device and a storage medium.

### BACKGROUND

With the continuous progress of computer animation technology, audio-driven facial expression animation of a virtual object has been developed, such as facial expression animation of a virtual anchor, and is consistent with the audio stream generated based on input audio.

### SUMMARY

According to a first aspect of the disclosure, a method for animation synthesis is provided. The method includes: obtaining an audio stream to be processed and a syllable sequence, in which both the audio stream and the syllable sequence correspond to the same text, and each syllable in the syllable sequence is pinyin of each character of the text; obtaining a phoneme information sequence of the audio stream by performing phoneme detection on the audio stream, in which each piece of phoneme information in the phoneme information sequence includes a phoneme category and a pronunciation time period; determining a pronunciation time period corresponding to each syllable in the syllable sequence based on the syllable sequence, phoneme categories and pronunciation time periods in the phoneme information sequence; and generating an animation video corresponding to the audio stream based on the pronunciation time period corresponding to each syllable in the syllable sequence and an animation frame sequence corresponding to each syllable.

According to a second aspect of the disclosure, an electronic device is provided. The electronic device includes: at least one processor and a memory communicatively coupled to the at least one processor. The memory stores instructions executable by the at least one processor, and when the instructions are executed by the at least one processor, the at least one processor is caused to implement the method according to the first aspect of the disclosure.

According to a third aspect of the disclosure, a non-transitory computer-readable storage medium having computer instructions stored thereon is provided. The computer instructions are configured to cause a computer to implement the method according to the first aspect of the disclosure.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure.

FIG. 1 is a schematic diagram of a first embodiment of the disclosure.

FIG. 2 is a schematic diagram of a second embodiment of the disclosure.

FIG. 3 is a schematic diagram of a third embodiment of the disclosure.

FIG. 4 is a schematic diagram of a fourth embodiment of the disclosure.

FIG. 5 is a schematic diagram of a fifth embodiment of the disclosure.

FIG. 6 is a schematic diagram of a sixth embodiment of the disclosure.

FIG. 7 is a schematic diagram of an animation synthesis scene according to an embodiment of the disclosure.

FIG. 8 is a schematic diagram of a seventh embodiment of the disclosure.

FIG. 9 is a schematic diagram of an electronic device configured to perform animation synthesis according to an embodiment of the disclosure.

### DETAILED DESCRIPTION

The following describes the embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications may be made to the embodiments described herein without departing from the scope of the disclosure. For clarity and conciseness, descriptions of well-known functions and structures are omitted in the following description.

In the related art, sequence-to-sequence modeling is performed on an audio sequence and a facial expression sequence, and a mapping relation between the audio space and the facial expression space is learned based on a recurrent neural network method. However, the above method has the following problems. Firstly, inter-frame jitter for the generated facial expressions is obvious. Secondly, the generated facial expressions are relatively false. Thirdly, the audio and the shape of a mouth are out of sync. Fourthly, due to non-deterministic mapping relation between the audio space and the facial expression space, the model is difficult to converge. Fifthly, performance of a test set other than a training set is poor, and the generalization is relatively weak.

In view of the above problems, the disclosure provides a method for animation synthesis, an apparatus for animation synthesis, an electronic device and a storage medium.

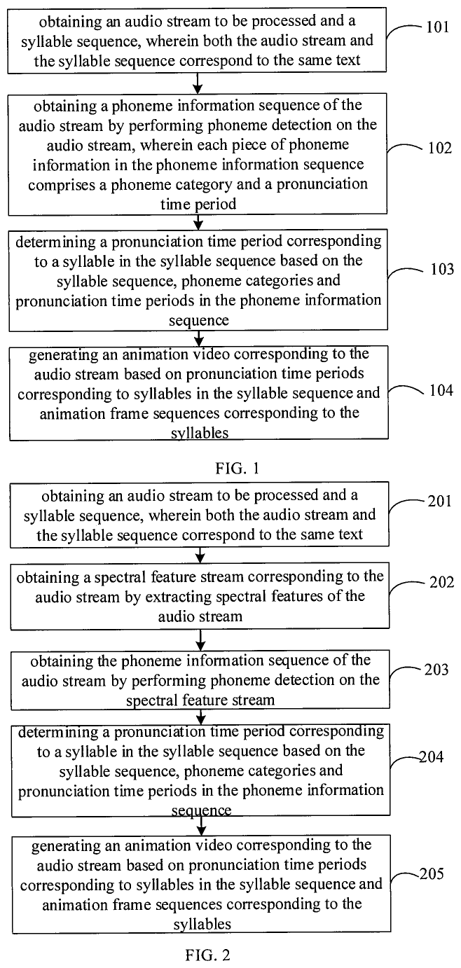

FIG. 1 is a schematic diagram of a first embodiment of the disclosure. It should be noted that the method for animation synthesis in the embodiments of the disclosure may be applied to the apparatus for animation synthesis in the embodiments of the disclosure, and the apparatus may be configured in an electronic device. The electronic device may be a mobile terminal, for example, a hardware device with various operating systems such as a mobile phone, a tablet computer, and a personal digital assistant.

As shown in FIG. 1, this method for animation synthesis includes the following steps.

At 101, an audio stream to be processed and a syllable sequence are obtained, in which both the audio stream and the syllable sequence correspond to the same text.

In the embodiments of the disclosure, the apparatus for animation synthesis obtains a text to be processed, performs speech synthesis on the text to obtain a synthesized audio stream, and determines the audio stream as the audio stream to be processed. Further, a syllable corresponding to each character in the text is obtained and spliced to obtain the syllable sequence corresponding to the text. Specifically, the syllable corresponding to the character refers to pinyin of the character.

Before the syllable corresponding to each character in the text is obtained, in order to avoid missing special characters in the text and ensure consistency between the text and the syllable sequence, the special characters in the text may be normalized, that is, the special characters in the text may be converted into Chinese characters to obtain a processed text. Then, the syllable corresponding to each character in the processed text is obtained to generate a syllable sequence. The special characters may include at least one of: Arabic numerals, dates, money symbols and unit symbols. The unit symbols are, for example, weight unit symbols and length unit symbols.

In the embodiments of the disclosure, the text may be any text, such as phrases, sentences and paragraphs, which may be set according to actual needs.

At 102, a phoneme information sequence of the audio stream is obtained by performing phoneme detection on the audio stream, in which each piece of phoneme information in the phoneme information sequence includes a phoneme category and a pronunciation time period.

In order to realize timing alignment between the audio stream and the syllable sequence, the phoneme information sequence of the audio stream may be obtained first. In the embodiments of the disclosure, the phoneme detection may be performed on the audio stream to obtain the phoneme information sequence of the audio stream. It should be noted that each piece of phoneme information in the phoneme information sequence may include: a phoneme category and a pronunciation time period. The phoneme category may include multiple phonemes, and each phoneme category corresponds to a syllable. The pronunciation time period may be a pronunciation start time and a pronunciation end time of the phoneme category. For example, if the phoneme category is “wo”, the pronunciation time period may be “0.1 ms to 0.3 ms”.

In order to obtain the phoneme information sequence of the audio stream more accurately, spectrum features of the audio stream may be extracted, and phoneme detection is performed on the spectrum features corresponding to the audio stream, in order to obtain the phoneme information sequence of the audio stream.

At 103, a pronunciation time period corresponding to a syllable in the syllable sequence is determined based on the syllable sequence, phoneme categories and pronunciation time periods in the phoneme information sequence.

It may be understood that the syllables in the syllable sequence have a corresponding relation with the phoneme categories in the phoneme information sequence. For example, the syllable “wo” in the syllable sequence has a corresponding relation with the phoneme category of “wo” in the phoneme information sequence. Therefore, for a syllable in the syllable sequence, the pronunciation time period corresponding to the syllable may be determined based on the pronunciation time period of the phoneme category corresponding to the syllable. It should be noted that the above step of determining the pronunciation time period may be performed for each syllable in the syllable sequence. The above step of determining the pronunciation time period may be performed for each syllable in the syllable sequence, respectively, to obtain the pronunciation time period corresponding to each syllable in the syllable sequence.

At 104, an animation video corresponding to the audio stream is generated based on pronunciation time periods corresponding to the syllables in the syllable sequence and animation frame sequences corresponding to the syllables.

Since the pronunciation time period in the syllable sequence is determined based on the pronunciation time period corresponding to the phoneme category in the phoneme information sequence, a duration of the pronunciation time period corresponding to the syllable may be determined based on the pronunciation time period corresponding to the syllable in the syllable sequence, the animation frame sequence corresponding to the syllable may be processed based on the duration, and the animation video corresponding to the audio stream may be thus generated.

In conclusion, the phoneme information sequence of the audio stream is obtained by performing phoneme detection on the audio stream. The pronunciation time period corresponding to the syllable in the syllable sequence is determined based on the syllable sequence, and the phoneme information in the syllable sequence. At last, the animation video corresponding to the audio stream is generated based on the pronunciation time periods corresponding to the syllables in the syllable sequence and the animation frame sequence corresponding to the syllables. In this way, the animation video and the audio stream have high consistency without no inter-frame jitter, and thus the authenticity and generalization of the animation video is enhanced.

In order to accurately obtain the phoneme information sequence of the audio stream, phoneme detection may be performed on the audio stream to obtain the phoneme information sequence of the audio stream. As shown in FIG. 2, FIG. 2 is a schematic diagram of a second embodiment of the disclosure. As an example, spectral features of the audio stream may be extracted to obtain a spectral feature stream corresponding to the audio stream. The phoneme information sequence of the audio stream is obtained based on the spectral feature stream, the embodiment shown in FIG. 2 may include the following steps.

At 201, an audio stream to be processed and a syllable sequence are obtained, and both the audio stream and the syllable sequence correspond to the same text.

At 202, a spectral feature stream corresponding to the audio stream is obtained by extracting spectral features of the audio stream.

That is, for an audio stream having a short duration, Fourier transform of the audio stream may be carried out to convert the audio stream into a spectrum picture, and spectrum feature extraction on the spectrum picture may be carried out to obtain the spectrum feature stream corresponding to the audio stream.

At 203, the phoneme information sequence of the audio stream is obtained by performing phoneme detection on the spectral feature stream.

Further, phoneme detection may be carried out to the spectral feature stream by a visual detection model, and the visual detection model may output a detection result, in which the detection result may include each of the phoneme categories, a pronunciation start time and a pronunciation end time corresponding to each phoneme category. According to the phoneme categories and the pronunciation start time and pronunciation end time of each phoneme category, the phoneme information sequence of the audio stream may be obtained. The phoneme information in the phoneme information sequence may include phoneme categories and pronunciation time periods. The visual detection model may be a trained neural network.

At 204, pronunciation time periods corresponding to syllables in the syllable sequence are obtained based on the syllable sequence, phoneme categories and pronunciation time periods in the phoneme information sequence.

At 205, an animation video corresponding to the audio stream is generated based on pronunciation time periods corresponding to the syllables in the syllable sequence and animation frame sequences corresponding to the syllables.

It should be noted that, steps at 201 and 204-205 may be implemented in any of the embodiments of the disclosure, which are not limited in the embodiments of the disclosure, and will not be repeated.

In conclusion, the spectral feature stream corresponding to the audio stream is obtained by extracting spectral features of the audio stream. Moreover, phoneme detection is performed on the spectral feature stream to obtain the phoneme information sequence of the audio stream. Thereby, the phoneme information sequence of the audio stream may be accurately acquired.

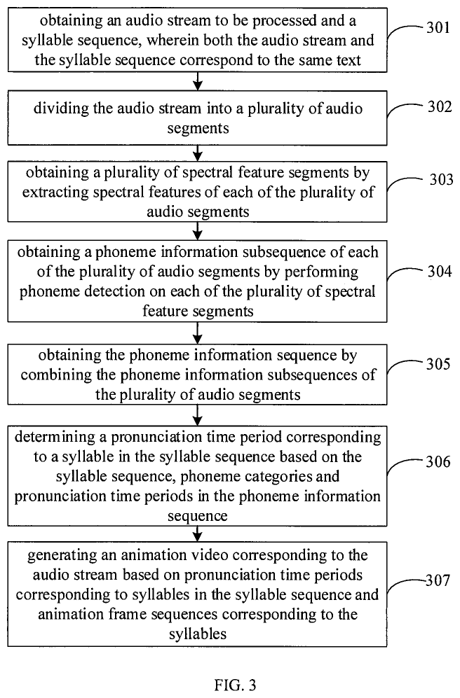

As shown in FIG. 3, FIG. 3 is a schematic diagram of a third embodiment of the disclosure. As another example, the audio stream may be divided into a plurality of audio segments, and spectrum features of each of the plurality of audio segments may be extracted to obtain a plurality of spectrum feature segments, and based on the plurality of spectrum feature segments, the phoneme information sequence is obtained. The embodiment shown in FIG. 3 may include the following steps.

At 301, an audio stream to be processed and a syllable sequence are obtained, and both the audio stream and the syllable sequence correspond to the same text.

At 302, the audio stream is divided into a plurality of audio segments.

It should be understood that, the phoneme information sequence of a long audio stream obtained by directly performing phoneme detection on the long audio stream is rather complex, thus in order to reduce complexity of the phoneme information sequence of the long audio stream, the audio stream may be divided into the plurality of audio segments.

At 303, a plurality of spectral feature segments are obtained by extracting spectral features of each of the plurality of audio segments.

The plurality of audio segments are converted into a plurality of spectrum pictures respectively through the Fourier transform, and the spectrum feature extraction may be performed on the plurality of spectrum pictures respectively, to obtain the plurality of spectrum feature segments.

At 304, a phoneme information subsequence of each of the audio segments is obtained by performing phoneme detection on each of the spectral feature segments.

In the embodiments of the disclosure, phoneme detection may be performed on each of the plurality of spectral feature segments by the visual detection model, and the visual detection model may output a plurality of phoneme detection results, in which each phoneme detection result may include a plurality of phoneme categories, the pronunciation start time and the pronunciation end time of each phoneme category, and the phoneme information subsequence of the corresponding audio segment may be obtained based on each phoneme category and the start time and end time of each phoneme category.

At 305, the phoneme information sequence is obtained by combining the phoneme information subsequences of the plurality of audio segments.

Optionally, based on time period information of the audio segments in the audio stream, pronunciation time periods of a plurality of phoneme information subsequences are adjusted to obtain adjusted phoneme information subsequences. The adjusted phoneme information subsequences are combined to obtain the phoneme information sequence.

That is, in order to improve the accuracy of the phoneme information sequence, based on the time period information of the plurality of audio segments in the audio stream, the pronunciation time periods in the plurality of phoneme information subsequences may be adjusted to the time period information in the audio stream, and the adjusted phoneme information subsequences are spliced to obtain the phoneme information sequence.

At 306, pronunciation time periods corresponding to syllables in the syllable sequence are determined based on the syllable sequence, phoneme categories and pronunciation time periods in the phoneme information sequence.

At 307, an animation video corresponding to the audio stream is generated based on pronunciation time periods corresponding to the syllables in the syllable sequence and animation frame sequences corresponding to the syllables.

It should be noted that steps at 301 and 306-307 may be implemented in any of the embodiments of the disclosure, which are not limited in the embodiments of the disclosure, and will not be described again.

In conclusion, the audio stream is divided into the plurality of audio segments. The plurality of spectrum feature segments are obtained by extracting spectrum features of each of the plurality of audio segments. The phoneme information subsequences of each of the plurality of audio segments are obtained by performing phoneme detection on the plurality of spectral feature segments respectively. The phoneme information subsequences of the plurality of audio segments are combined to obtain the phoneme information sequence. Thus, the phoneme information sequence of the audio stream may be accurately acquired, and the complexity of the phoneme information sequence obtained from the audio stream is reduced.

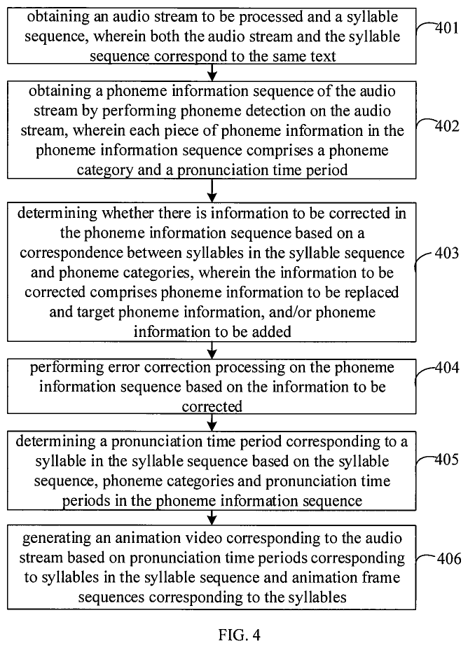

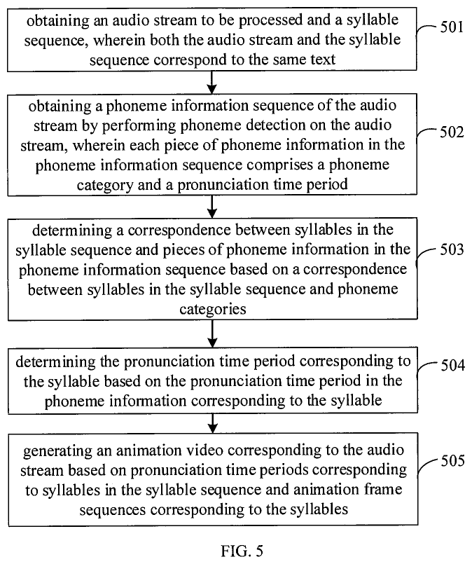

In order to further improve the accuracy of the phoneme information sequence, as shown in FIG. 4, FIG. 4 is a schematic diagram of a fourth embodiment of the disclosure. In the embodiments of the disclosure, after the phoneme information sequence of the audio stream is obtained by performing phoneme detection on the audio stream, it is determined whether there is information to be corrected in the phoneme information sequence based on a correspondence between syllables in the syllable sequence and phoneme categories. When it is determined that there is the information to be corrected in the phoneme information sequence, error correction processing is performed on the phoneme information sequence. The embodiment shown in FIG. 4 may include the following steps.

At 401, an audio stream to be processed and a syllable sequence are obtained, in which both the audio stream and the syllable sequence correspond to the same text.

At 402, a phoneme information sequence of the audio stream is obtained by performing phoneme detection on the audio stream, in which each piece of phoneme information in the phoneme information sequence includes a phoneme category and a pronunciation time period.

At 403, it is determined whether there is information to be corrected in the phoneme information sequence based on a correspondence between syllables in the syllable sequence and phoneme categories, in which the information to be corrected includes phoneme information to be replaced and target phoneme information, and/or phoneme information to be added

In the embodiments of the disclosure, since there is a correspondence (e.g., one-to-one correspondence) between the syllables in the syllable sequence and the phoneme categories in the phoneme information sequence. When a phoneme category in the phoneme information sequence does not have a corresponding syllable in the syllable sequence, it is determined that false detection or missed detection may occur for the phoneme category, and there is information to be corrected in the phoneme information sequence.

In addition, in order to improve the accuracy of the phoneme information sequence, when the pronunciation time period corresponding to the phoneme category in the phoneme information sequence is relatively long, truncation processing may be performed on a pronunciation time period of the phoneme category having a long pronunciation period in the phoneme information sequence, so as to shorten the pronunciation time period corresponding to the phoneme category. According to different positions of the phoneme categories in the phoneme information sequence, the processing methods after the pronunciation time period corresponding to the phoneme category is performed are also different. For example, when the phoneme category is at the end of the phoneme information sequence, the truncation processing may be performed directly on the pronunciation time period corresponding to the phoneme category. For example, when the phoneme category is in the middle of the phoneme information sequence, a difference between an original pronunciation period of the phoneme category and a pronunciation time period of the phoneme category after the pronunciation time truncation process may be assigned to other phoneme categories that are adjacent to the phoneme category in the phoneme information sequence.

At 404, error correction processing is performed on the phoneme information sequence based on the information to be corrected.

For example, when there is a wrongly detected phoneme category in the phoneme information sequence, the wrongly detected phoneme category (the phoneme information to be replaced) may be replaced with the correct phoneme category (the target phoneme information). For example, when there is a missed phoneme category in the phoneme information sequence, the missed phoneme category (the phoneme information to be added) may be added based on the corresponding pronunciation time period. For example, if there are both the wrongly detected and the missed phoneme category in the phoneme information sequence, the wrongly detected phoneme category may be replaced with the correct phoneme category, and at the same time, the missed phoneme category is added based on the pronunciation time period corresponding to the phoneme category. It should be noted that the information to be corrected includes: phoneme information to be replaced and target phoneme information, and/or phoneme information to be added.

At 405, pronunciation time periods corresponding to syllables in the syllable sequence are determined based on the syllable sequence, and phoneme categories and pronunciation time periods in the phoneme information sequence.

At 406, an animation video corresponding to the audio stream is generated based on pronunciation time periods corresponding to the syllables in the syllable sequence and animation frame sequences corresponding to the syllables.

It should be noted that steps at 401-402 and 405-406 may be implemented in any of the embodiments of the disclosure, which are not limited in the embodiments of the disclosure, and will not be described again.

In conclusion, it is determined whether there is information to be corrected in the phoneme information sequence based on the correspondence between the syllables and the phoneme categories. The information to be corrected includes phoneme information to be replaced and target phoneme information, and/or phoneme information to be added. At last, error correction processing is performed on the phoneme information sequence based on the information to be corrected. Thus, the accuracy of the phoneme information sequence may be further improved.

In order to accurately determine the pronunciation time period corresponding to a syllable, as shown in FIG. 5, FIG. 5 is a schematic diagram of a fifth embodiment of the disclosure. In the embodiments of the disclosure, a correspondence between syllables in the syllable sequence and pieces of phoneme information in the phoneme information sequence may be determined based on a correspondence between syllables in the syllable sequence and phoneme categories. Further, based on the pronunciation time period in the phoneme information corresponding to the syllable, the pronunciation time period corresponding to the syllable is determined. The embodiment shown in FIG. 5 may include the following steps.

At 501, an audio stream to be processed and a syllable sequence are obtained, in which both the audio stream and the syllable sequence correspond to the same text.

At 502, a phoneme information sequence of the audio stream is obtained by performing phoneme detection on the audio stream, in which each piece of phoneme information in the phoneme information sequence includes a phoneme category and a pronunciation time period.

At 503, a correspondence between syllables in the syllable sequence and pieces of phoneme information in the phoneme information sequence is determined based on a correspondence between syllables in the syllable sequence and phoneme categories.

In the embodiments of the disclosure, since there is a correspondence between the syllables in the syllable sequence and the phoneme categories in the phoneme information sequence, a correspondence between syllables in the syllable sequence and pieces of phoneme information in the phoneme information sequence may be determined based on the correspondence between the syllables in the syllable sequence and the phoneme categories in the phoneme information sequence. For example, the phoneme category included in the phoneme information in the phoneme information sequence corresponds to the syllable in the syllable sequence, and the pronunciation time period of the syllable in the syllable sequence corresponds to the pronunciation time period in the phoneme information corresponding to the syllable.

At 504, the pronunciation time period corresponding to the syllable is determined based on the pronunciation time period in the phoneme information corresponding to the syllable.

Further, since syllables in the syllable sequence correspond to pieces of phoneme information in the phoneme information sequence, the pronunciation time period corresponding to the syllable in the syllable sequence is determined based on the pronunciation time period in the phoneme information corresponding to the syllable.

At 505, an animation video corresponding to the audio stream is generated based on pronunciation time periods corresponding to the syllables in the syllable sequence and animation frame sequences corresponding to the syllables.

It should be noted that, steps at 501-502 and 505 may be implemented in any of the embodiments of the disclosure, which are not limited in the embodiments of the disclosure, and will not be repeated.

In conclusion, the correspondence between the syllables in the syllable sequence and the pieces of phoneme information in the phoneme information sequence is determined based on the correspondence between the syllables in the syllable sequence and the phoneme categories. The pronunciation time period corresponding to the syllable is determined based on the pronunciation time period in the phoneme information corresponding to the syllable. Thus, the pronunciation time period corresponding to the syllable may be accurately determined.

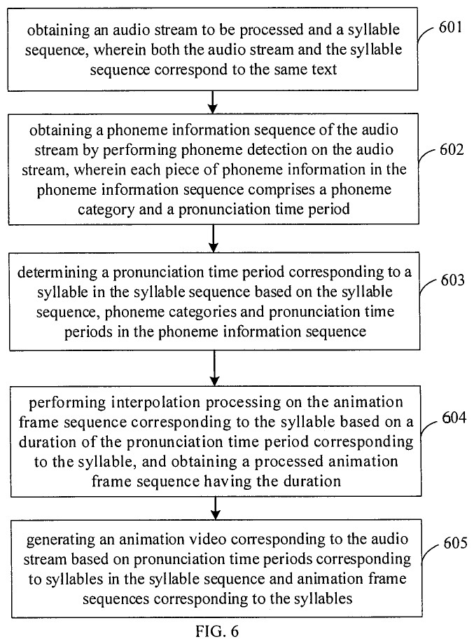

In order to generate the animation video corresponding to the audio stream, as shown in FIG. 6, FIG. 6 is a schematic diagram of a sixth embodiment of the disclosure. In the embodiments of the disclosure, the animation frame sequences corresponding to the syllables may be processed based on the duration of the pronunciation time period corresponding to the syllable in the syllable sequence to obtain the processed sequence for animation frame having the duration. The animation video is generated based on the processed animation frame sequence corresponding to the syllable in the syllable sequence. The embodiment shown in FIG. 6 may include the following steps.

At 601, an audio stream to be processed and a syllable sequence are obtained, in which both the audio stream and the syllable sequence correspond to the same text.

At 602, a phoneme information sequence of the audio stream is obtained by performing phoneme detection on the audio stream, in which each piece of phoneme information in the phoneme information sequence includes a phoneme category and a pronunciation time period.

At 603, a pronunciation time period corresponding to a syllable in the syllable sequence is determined based on the syllable sequence, and phoneme categories and pronunciation time periods in the phoneme information sequence.

At 604, interpolation processing is performed on the animation frame sequence corresponding to the syllable based on a duration of the pronunciation time period corresponding to the syllable, and a processed animation frame sequence having the duration is determined.

That is, for a syllable in the syllable sequence, the animation frame sequence corresponding to the syllable may be queried in an animation dictionary. Interpolation processing (for example, compression processing) is performed on the animation frame sequence corresponding to the syllable based on a duration of the pronunciation time period corresponding to the syllable, to obtain a processed animation frame sequence having the duration. It should be noted that, the above steps of interpolation processing may be performed for each syllable or a part of the syllables in the syllable sequence. Taking each syllable as an example, the above interpolation processing step may be performed on each syllable in the syllable sequence to obtain a processed animation frame sequence corresponding to each syllable in the syllable sequence.

At 605, an animation video is generated based on the processed animation frame sequences corresponding to the syllables in the syllable sequence.

In the embodiments of the disclosure, in order to avoid inter-frame jitter and ensure a natural transition between frames, a head animation frame of an animation frame sequence and a tail animation frame of an adjacent animation frame sequence are adjusted.

As an example, for a first tail animation frame in the processed animation frame sequence corresponding to the syllable in the syllable sequence, a first head animation frame in the processed animation frame sequence corresponding to a first adjacent syllable is obtained. Moreover, animation coefficients of the first tail animation frame are adjusted based on animation coefficients of the first head animation frame to obtain the adjusted animation frame sequence corresponding to the syllable, in which a pronunciation time period corresponding to the first adjacent syllable is located behind a pronunciation time period corresponding to the syllable. The above steps may be performed for each syllable or a part of the syllables in the syllable sequence. Furthermore, based on the adjusted animation frame sequence corresponding to each syllable in the syllable sequence, an animation video may be generated.

The specific implementation of adjusting the animation coefficients of the first tail animation frame based on the animation coefficients of the first head animation frame may be, for example, addition processing the animation coefficients of the first head animation frame and the animation coefficients of the first tail animation frame to obtain the addition processed animation coefficients; determining the addition processed animation coefficients as the adjusted animation coefficients of the first tail animation frame, and determining the adjusted first tail animation frame; and generating the adjusted animation frame sequence corresponding to the syllable by combining non-tail animation frames and the adjusted first tail animation frame in the processed animation frame sequence corresponding to the syllable.

As another example, for a second head animation frame in the processed animation frame sequence corresponding to the syllable in the syllable sequence, a second tail animation frame in the processed animation frame sequence corresponding to a second adjacent syllable is obtained. According to animation coefficients of the second tail animation frame, animation coefficients of the second head animation frame are adjusted to obtain the adjusted animation frame sequence corresponding to the syllable, in which a pronunciation time period corresponding to the second adjacent syllable is located before the pronunciation time period corresponding to the syllable. The above steps may be performed for each syllable or a part of the syllables in the syllable sequence. Furthermore, the adjusted animation frame sequences corresponding to the syllables in the syllable sequence are spliced to generate a animation video.

The specific implementation of adjusting the animation coefficients of the second head animation frame based on the animation coefficients of the second tail animation frame can be, for example, addition processing the animation coefficients of the second head animation frame and the animation coefficients of the second tail animation frame to obtain addition processed animation coefficients; determining the addition processed animation coefficients as the adjusted animation coefficients of the second head animation frame, and determining the adjusted second head animation frame; and generating the adjusted animation frame sequence corresponding to the syllable by combining non-head animation frames and the adjusted second head animation frame in the processed animation frame sequence corresponding to the syllable.

As another example, for the first tail animation frame in the processed animation frame sequence corresponding to the syllable in the syllable sequence, the first head animation frame in the processed animation frame sequence corresponding to the first adjacent syllable is obtained. According to the animation coefficients of the first head animation frame, the animation coefficients of the first tail animation frame are adjusted to obtain the adjusted animation frame sequence corresponding to the syllable, in which the pronunciation time period corresponding to the first adjacent syllable is located behind the pronunciation time period corresponding to the syllable. For the second head animation frame in the processed animation frame sequence corresponding to the syllable in the syllable sequence, the second tail animation frame in the processed animation frame sequence corresponding to the second adjacent syllable is obtained. According to the animation coefficients of the second tail animation frame, the animation coefficients of the second head animation frame are adjusted to obtain the adjusted animation frame sequence corresponding to the syllable, in which the pronunciation time period corresponding to the second adjacent syllable is located before the pronunciation time period corresponding to the syllable. For each syllable or a part of the syllables in the syllable sequence, the above steps may be performed respectively. Taking a part of syllables as an example, a part of the above-mentioned steps may be performed for some in the part of syllables and another part of the above-mentioned steps may be performed for other remaining ones in the part of syllables, or the above-mentioned steps are not performed for the other remaining syllables. Afterwards, the animation video is generated based on the adjusted animation frame sequences corresponding to the syllables in the syllable sequence.

In the embodiments of the disclosure, the animation coefficients of the animation frame can represent the facial expression in the animation frame. In an example, when the animation coefficients represent facial expressions, the animation coefficients may be coefficients of each face part in the animation frame, such as a distance between the eyes, a distance between the nose and the center of the eyes, which may be determined based on actual needs.

In the embodiments of the disclosure, in another example, when the animation coefficients represent facial expressions, the animation coefficients may be relative coefficients of each face part in an animation frame with respect to a basic animation frame. That is, the animation coefficients in the basic animation frame may be the coefficients of each face part in the basic animation frame. The animation coefficients of other animation frames may be offset values between the coefficients of each face part in the other animation frames and the coefficients of the corresponding coefficients of each face part in the basic animation frame. The basic animation frame and its animation coefficients may be preset.

The setting of the animation coefficients can facilitate a terminal device to perform rendering based on the animation coefficients, in order to obtain corresponding animation frames, and reduce the amount of data when the animation frames are transmitted.

In addition, in order to make switching of the processed animation frame sequence corresponding to each syllable more continuous and natural, edges of the processed animation frame sequence corresponding to each syllable are stretched and superimposed horizontally, and the processed animation frame sequence corresponding to each syllable is subjected to filter smoothing processing, so as to reduce the inter-frame jitter of the animation video.

In conclusion, for each syllable in the syllable sequence, interpolation processing is performed on the animation frame sequence corresponding to the syllable based on a duration of the pronunciation time period corresponding to the syllable, to obtain a processed animation frame sequence having the duration. The animation video is generated based on the processed animation frame sequences corresponding to the syllables in the syllable sequence. Therefore, the animation video and the audio stream have high consistency without inter-frame jitter, thus the authenticity and generalization of the animation video is enhanced.

In order to illustrate the above-mentioned embodiments more clearly, examples will be described.

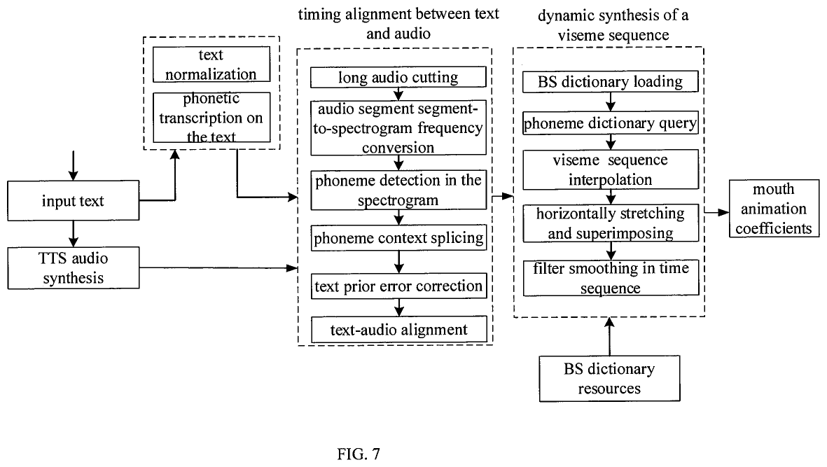

For example, as shown in FIG. 7, taking mouth animation synthesis as an example, speech synthesis processing is carried out on the input text to obtain an audio stream. Simultaneously, text normalization and Chinese character transliteration processing are carried out on the input text, to obtain a syllable sequence. The text normalization processing may include converting Arabic numerals, symbols, dates, and money symbols in the text into Chinese characters. Further, in order to realize a timing alignment between text and audio, long audio cutting, audio segment-to-spectrogram conversion, phoneme detection in the spectrogram, phoneme context splicing, text prior error correction and text-audio alignment may be performed. Further, based on a timing alignment relation between text and audio, dynamic interpolation of an animation frame sequence is performed by querying a mouth animation dictionary. In order to make the mouth animation more continuous and natural when switching among characters, edges in the mouth animation frame at each character are stretched and superimposed horizontally, and filter smoothing processing is performed on all the mouth animation frame sequences in time sequence, so as to make the animation smoother and more fluent, and reduce the inter-frame jitter of the animation video.

According to the method for animation synthesis in the embodiments of the disclosure, the phoneme information sequence of the audio stream is obtained by performing phoneme detection on the audio stream. The pronunciation time period corresponding to a syllable in the syllable sequence is determined based on the syllable sequence and the phoneme information in the syllable sequence. At last, the animation video corresponding to the audio stream is generated based on the pronunciation time periods corresponding to the syllables in the syllable sequence and the animation frame sequences corresponding to the syllables. In this way, the animation video and the audio stream have high consistency without no inter-frame jitter, thus the authenticity and generalization of the animation video is enhanced.

In order to realize the above embodiments, the disclosure also provides an apparatus for animation synthesis.

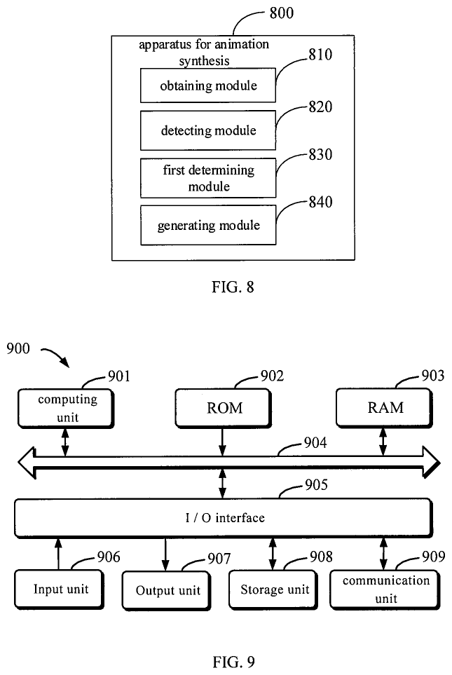

As shown in FIG. 8, FIG. 8 is a schematic diagram of a seventh embodiment of the disclosure. The apparatus 800 for animation synthesis includes: an obtaining module 810, a detecting module 820, a first determining module 830 and a generating module 840.

The obtaining module 810 is configured to obtain an audio stream to be processed and syllable sequence, in which both the audio stream and the syllable sequence correspond to the same text. The detecting module 820 is configured to obtain a phoneme information sequence of the audio stream by performing phoneme detection on the audio stream, in which each piece of phoneme information in the phoneme information sequence includes a phoneme category and a pronunciation time period. The first determining module 830 is configured to determine a pronunciation time period corresponding to a syllable in the syllable sequence based on the syllable sequence, phoneme categories and pronunciation time periods in the phoneme information sequence. The generating module 840 is configured to generate an animation video corresponding to the audio stream based on the pronunciation time periods corresponding to syllables in the syllable sequence and animation frame sequences corresponding to the syllables.

In a possible implementation, the detecting module 820 is further configured to: obtain a spectral feature stream corresponding to the audio stream by extracting spectral features of the audio stream; and obtain the phoneme information sequence of the audio stream by performing phoneme detection on the spectral feature stream.

In a possible implementation, the detecting module 820 is further configured to: divide the audio stream into a plurality of audio segments; obtain a plurality of spectral feature segments by extracting spectral features of each of the plurality of audio segments; obtain a phoneme information subsequence of each of the plurality of audio segments by performing phoneme detection on each of the plurality of spectral feature segments; and obtain the phoneme information sequence by combining the phoneme information subsequences of the plurality of audio segments.

In a possible implementation, the detecting module is further configured to: obtain a plurality of adjusted phoneme information subsequences by adjusting the pronunciation time periods of the phoneme information subsequences based on time period information of the plurality of audio segments in the audio stream; and obtain the phoneme information sequence by combining the plurality of adjusted phoneme information subsequences.

In a possible implementation, the apparatus further includes: a second determining module and a processing module. The second determining module is configured to determine whether there is information to be corrected in the phoneme information sequence based on a correspondence between syllables in the syllable sequence and phoneme categories, in which the information to be corrected comprises phoneme information to be replaced and target phoneme information, and/or phoneme information to be added. The processing module is configured to perform error correction processing on the phoneme information sequence based on the information to be corrected.

In a possible implementation, the first determining module is further configured to: determine a correspondence between syllables in the syllable sequence and pieces of phoneme information in the phoneme information sequence based on a correspondence between syllables in the syllable sequence and phoneme categories; and determine the pronunciation time period corresponding to the syllable based on the pronunciation time period in the phoneme information corresponding to the syllable.

In a possible implementation, the generating module is further configured to: perform interpolation processing on the animation frame sequence corresponding to the syllables based on a duration of the pronunciation time period corresponding to the syllable, and obtain a processed animation frame sequence having the duration; and generate the animation video based on the processed animation frame sequences corresponding to the syllables in the syllable sequence.

In a possible implementation, the generating module 840 is further configured to: obtain a first head animation frame in a processed animation frame sequence corresponding to a first adjacent syllable for a first tail animation frame in the processed animation frame sequence corresponding to the syllable in the syllable sequence; and obtain an adjusted animation frame sequence corresponding to the syllable by adjusting animation coefficients of the first tail animation frame based on animation coefficients of the first head animation frame, wherein a pronunciation time period corresponding to the first adjacent syllable is located behind the pronunciation time period corresponding to the syllable; and/or, obtain a second tail animation frame in a processed animation frame sequence corresponding to a second adjacent syllable for a second head animation frame in the processed animation frame sequence corresponding to the syllable in the syllable sequence; and obtain the adjusted animation frame sequence corresponding to the syllable by adjusting animation coefficients of the second head animation frame based on animation coefficients of the second tail animation frame, wherein a pronunciation time period corresponding to the second adjacent syllable is located before the pronunciation time period corresponding to the syllable; and generate the animation video based on the adjusted animation frame sequences corresponding to each syllable in the syllable sequence.

With the apparatus for animation synthesis in the embodiments of the disclosure, the phoneme information sequence of the audio stream is obtained by performing phoneme detection on the audio stream. The pronunciation time period corresponding to a syllable in the syllable sequence is determined based on the syllable sequence, and the phoneme information in the syllable sequence. At last, the animation video corresponding to the audio stream is generated based on the pronunciation time periods corresponding to the syllables in the syllable sequence and the animation frame sequences corresponding to the syllables. In this way, the animation video and the audio stream have high consistency without no inter-frame jitter occurs, thus the authenticity and generalization of the animation video is enhanced.

In the technical solution of the disclosure, the acquisition, storage and application of the personal information involved, all in line with the relevant laws and regulations, and do not violate public order and good custom.

According to the embodiments of the disclosure, the disclosure also provides an electronic device, a readable storage medium and a computer program product.

FIG. 9 is a block diagram of an example electronic device 900 used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 9, the device 900 includes a computing unit 901 performing various appropriate actions and processes based on computer programs stored in a read-only memory (ROM) 902 or computer programs loaded from the storage unit 908 to a random access memory (RAM) 903. In the RAM 903, various programs and data required for the operation of the device 900 are stored. The computing unit 901, the ROM 902, and the RAM 903 are connected to each other through a bus 904. An input/output (I/O) interface 905 is also connected to the bus 904.

Components in the device 900 are connected to the I/O interface 905, including: an inputting unit 906, such as a keyboard, a mouse; an outputting unit 907, such as various types of displays, speakers; a storage unit 908, such as a disk, an optical disk; and a communication unit 909, such as network cards, modems, and wireless communication transceivers. The communication unit 909 allows the device 900 to exchange information/data with other devices through a computer network such as the Internet and/or various telecommunication networks.

The computing unit 901 may be various general-purpose and/or dedicated processing components with processing and computing capabilities. Some examples of computing unit 901 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 901 executes the various methods and processes described above, such as the method for animation synthesis. For example, in some embodiments, the method may be implemented as a computer software program, which is tangibly in a machine-readable medium, such as the storage unit 908. In some embodiments, part or all of the computer program may be loaded and/or installed on the device 900 via the ROM 902 and/or the communication unit 909. When the computer program is loaded on the RAM 903 and executed by the computing unit 901, one or more steps of the method described above may be executed. Alternatively, in other embodiments, the computing unit 901 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein may be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, a distributed system server, or a server combined with a block-chain.

It should be understood that the various forms of processes shown above may be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions may be made according to design requirements and other factors. Any modification, equivalent replacement and improvement made within the spirit and principle of the disclosure shall be included in the protection scope of the disclosure.

What is claimed is:

1. A method for animation synthesis, comprising:
obtaining an audio stream to be processed and a syllable sequence, wherein both the audio stream and the syllable sequence correspond to the same text, and each syllable in the syllable sequence is pinyin of each character of the text;
obtaining a phoneme information sequence of the audio stream by performing phoneme detection on the audio stream, wherein each piece of phoneme information in the phoneme information sequence comprises a phoneme category and a pronunciation time period;
determining a pronunciation time period corresponding to each syllable in the syllable sequence based on the syllable sequence, phoneme categories and pronunciation time periods in the phoneme information sequence; and
generating an animation video corresponding to the audio stream based on the pronunciation time period corresponding to each syllable in the syllable sequence and an animation frame sequence corresponding to each syllable.

2. The method of claim 1, wherein obtaining the phoneme information sequence of the audio stream comprises:
obtaining a spectral feature stream corresponding to the audio stream by extracting spectral features of the audio stream; and
obtaining the phoneme information sequence of the audio stream by performing phoneme detection on the spectral feature stream.

3. The method of claim 1, wherein obtaining the phoneme information sequence of the audio stream comprises:
dividing the audio stream into a plurality of audio segments;
obtaining a plurality of spectral feature segments by extracting spectral features of each of the plurality of audio segments;
obtaining a phoneme information subsequence of each of the plurality of audio segments by performing phoneme detection on each of the plurality of spectral feature segments; and
obtaining the phoneme information sequence by combining the phoneme information subsequences of the plurality of audio segments.

4. The method of claim 3, wherein obtaining the phoneme information sequence by combining the phoneme information subsequences of the plurality of audio segments, comprises:
obtaining a plurality of adjusted phoneme information subsequences by adjusting pronunciation time periods of the phoneme information subsequences based on pieces of time period information of the plurality of audio segments in the audio stream; and
obtaining the phoneme information sequence by combining the plurality of adjusted phoneme information subsequences.

5. The method of claim 1, further comprising:
determining whether there is information to be corrected in the phoneme information sequence based on a correspondence between syllables in the syllable sequence and phoneme categories in the phoneme information sequence, wherein the information to be corrected comprises at least one of phoneme information to be replaced and target phoneme information, and phoneme information to be added; and
performing error correction on the phoneme information sequence based on the information to be corrected.

6. The method of claim 1, wherein determining the pronunciation time period corresponding to each syllable in the syllable sequence based on the syllable sequence, the phoneme categories and the pronunciation time periods in the phoneme information sequence, comprises:
determining a correspondence between syllables in the syllable sequence and pieces of phoneme information in the phoneme information sequence based on a correspondence between syllables in the syllable sequence and phoneme categories in the phoneme information sequence; and
determining the pronunciation time period corresponding to the syllable based on the pronunciation time period in the piece of phoneme information corresponding to the syllable.

7. The method of claim 1, wherein generating the animation video corresponding to the audio stream comprises:
performing interpolation on the animation frame sequence corresponding to the syllable based on a duration of the pronunciation time period corresponding to the syllable, and obtaining a processed animation frame sequence having the duration; and
generating the animation video based on the processed animation frame sequence corresponding to each syllable in the syllable sequence.

8. The method of claim 7, wherein generating the animation video comprises:
adjusting a first processed animation frame sequence corresponding to a first syllable in the syllable sequence based on a second processed animation frame sequence corresponding to a second syllable in the syllable sequence, wherein a pronunciation time period corresponding to the first syllable is adjacent to a pronunciation time period corresponding to the second syllable; and
generating the animation video based on the adjusted animation frame sequence corresponding to each syllable in the syllable sequence.

9. The method of claim 8, wherein adjusting the first processed animation frame sequence corresponding to the first syllable comprises at least one of:
adjusting animation coefficients of a tail animation frame of the first processed animation frame sequence based on animation coefficients of a head animation frame of the second processed animation frame sequence, wherein the pronunciation time period corresponding to the first syllable is located before the pronunciation time period corresponding to the second syllable;
adjusting animation coefficients of a head animation frame of the first processed animation frame sequence based on animation coefficients of a tail animation frame of the second processed animation frame sequence, wherein the pronunciation time period corresponding to the first syllable is located behind the pronunciation time period corresponding to the second syllable.

10. An electronic device, comprising:
at least one processor; and
a memory communicatively coupled to the at least one processor and configured to store instructions executable by the at least one processor;
wherein the at least one processor is caused to:
obtain an audio stream to be processed and a syllable sequence, wherein both the audio stream and the syllable sequence correspond to the same text, and each syllable in the syllable sequence is pinyin of each character of the text;
obtain a phoneme information sequence of the audio stream by performing phoneme detection on the audio stream, wherein each piece of phoneme information in the phoneme information sequence comprises a phoneme category and a pronunciation time period;
determine a pronunciation time period corresponding to each syllable in the syllable sequence based on the syllable sequence, phoneme categories and pronunciation time periods in the phoneme information sequence; and
generate an animation video corresponding to the audio stream based on the pronunciation time period corresponding to each syllable in the syllable sequence and an animation frame sequence corresponding to each syllable.

11. The electronic device of claim 10, wherein the at least one processor is further configured to:
obtain a spectral feature stream corresponding to the audio stream by extracting spectral features of the audio stream; and
obtain the phoneme information sequence of the audio stream by performing phoneme detection on the spectral feature stream.

12. The electronic device of claim 10, wherein the at least one processor is further configured to:
divide the audio stream into a plurality of audio segments;
obtain a plurality of spectral feature segments by extracting spectral features of each of the plurality of audio segments;
obtain a phoneme information subsequence of each of the plurality of audio segments by performing phoneme detection on each of the plurality of spectral feature segments; and
obtain the phoneme information sequence by combining the phoneme information subsequences of the plurality of audio segments.

13. The electronic device of claim 12, wherein the at least one processor is further configured to:
obtain a plurality of adjusted phoneme information subsequences by adjusting pronunciation time periods of the phoneme information subsequences based on pieces of time period information of the plurality of audio segments in the audio stream; and
obtain the phoneme information sequence by combining the plurality of adjusted phoneme information subsequences.

14. The electronic device of claim 10, wherein the at least one processor is further configured to:
determine whether there is information to be corrected in the phoneme information sequence based on a correspondence between syllables in the syllable sequence and phoneme categories in the phoneme information sequence, wherein the information to be corrected comprises phoneme information to be replaced and target phoneme information, and/or phoneme information to be added; and
perform error correction on the phoneme information sequence based on the information to be corrected.

15. The electronic device of claim 10, wherein the at least one processor is further configured to:
determine a correspondence between syllables in the syllable sequence and pieces of phoneme information in the phoneme information sequence based on a correspondence between syllables in the syllable sequence and phoneme categories in the phoneme information sequence; and
determine the pronunciation time period corresponding to the syllable based on the pronunciation time period in the piece of phoneme information corresponding to the syllable.

16. The electronic device of claim 10, wherein the at least one processor is further configured to:
perform interpolation on the animation frame sequence corresponding to the syllable based on a duration of the pronunciation time period corresponding to the syllable, and obtaining a processed animation frame sequence having the duration; and
generate the animation video based on the processed animation frame sequences corresponding to each syllable in the syllable sequence.

17. The electronic device of claim 16, wherein the at least one processor is further configured to:
adjust a first processed animation frame sequence corresponding to a first syllable in the syllable sequence based on a second processed animation frame sequence corresponding to a second syllable in the syllable sequence, wherein a pronunciation time period corresponding to the first syllable is adjacent to a pronunciation time period corresponding to the second syllable; and
generate the animation video based on the adjusted animation frame sequence corresponding to each syllable in the syllable sequence.

18. The electronic device of claim 17, wherein the at least one processor is further configured to perform at least one of:
adjusting animation coefficients of a tail animation frame of the first processed animation frame sequence based on animation coefficients of a head animation frame of the second processed animation frame sequence, wherein a pronunciation time period corresponding to the first syllable is located behind the pronunciation time period corresponding to the second syllable; and
adjusting animation coefficients of a head animation frame of the first processed animation frame sequence based on animation coefficients of a tail animation frame of the second processed animation frame sequence, wherein a pronunciation time period corresponding to the first syllable is located before the pronunciation time period corresponding to the second syllable.

19. A non-transitory computer readable storage medium having computer instructions stored thereon, wherein when the computer instructions are executed by a processor, a method for animation synthesis is implemented, the method comprising:
obtaining an audio stream to be processed and a syllable sequence, wherein both the audio stream and the syllable sequence correspond to the same text, and each syllable in the syllable sequence is pinyin of each character of the text;
obtaining a phoneme information sequence of the audio stream by performing phoneme detection on the audio stream, wherein each piece of phoneme information in the phoneme information sequence comprises a phoneme category and a pronunciation time period;
determining a pronunciation time period corresponding to each syllable in the syllable sequence based on the syllable sequence, phoneme categories and pronunciation time periods in the phoneme information sequence; and
generating an animation video corresponding to the audio stream based on the pronunciation time period corresponding to each syllable in the syllable sequence and an animation frame sequence corresponding to each syllable.
